(19) United States
(12) Patent Application Publication
(10) Pub. No.: US 2014/0047942 A1
(43) Pub. Date: Feb. 20, 2014

(54) CONTROL CABLE

(71) Applicants: Akira Tsuda, Takarazuka-shi (JP); Tomo Sakaguchi, Takarazuka-shi (JP)

(72) Inventors: Akira Tsuda, Takarazuka-shi (JP); Tomo Sakaguchi, Takarazuka-shi (JP)

(73) Assignee: HI-LEX CORPORATION, Takarazuka-shi, Hyogo (JP)

(21) Appl. No.: 14/113,273

(22) PCT Filed: Apr. 23, 2012
(86) PCT No.: PCT/JP2012/060894

§ 371 Date: Nov. 6, 2013

(30) Foreign Application Priority Data
Apr. 22, 2011 (JP) 2011-096452

(51) Int. Cl. F16C 1/20

(52) U.S. Cl. CPC F16C 1/20
USPC 74/502.5

(57) ABSTRACT

An object of the present invention is to provide a control cable having an outer casing provided with helically twisted metallic wires. The outer casing is light-weight, has a satisfactory buckling resistance, and can suspend generation of a vibrational noise. A control cable (1) is provided with an outer casing (2) and an inner cable (3). The outer casing (2) is provided with a liner (21), a plurality of wires (22) helically twisted around the liner (21), and a covering layer (23) formed on an outer side of the wires (22) in a radial direction of the outer casing (2). The material of the wires (22) is an aluminum alloy, and the pitch of the wires (22) is 10 to 35 times an outer diameter of a shield.

### TECHNICAL FIELD

The present invention relates to a light-weight control cable with which transmission of a vibration can be suppressed.

### BACKGROUND ART

As a conventional control cable, as illustrated in FIG. 10, a control cable has been disclosed in which an outer casing 100 is used. The outer casing 100 has a flexible inner tube 101, and around a periphery thereof, a plurality of oil tempered wires 102 and a plurality of easily-flexed wires 103 are helically twisted in a slack manner such that the wires are disposed in parallel, adhering, and adjacent to each other. On a periphery thereof, a synthetic resin covering layer 104 is formed (see Patent Literature 1).

In the above-described Patent Literature 1, with an outer casing in which a carbon steel oil tempered wire and a hard steel wire are disposed alternately in parallel, adhering to each other, and are helically twisted around the periphery of the flexible inner tube in a slack manner, the flexibility is insufficient. Therefore, the flexibility is provided by using the easily-flexed wire 103 having a soft steel wire or a hard steel twisted wire instead of the hard steel wire.

### CITATION LIST

### Patent Literature

Patent Literature 1: JP 2-113013 Y

### SUMMARY OF INVENTION

### Technical Problem

A control cable provided with an above-described outer casing 100, in which two types of steel wires helically twisted around are used, has satisfactory buckling resistance, but is heavy in weight since a steel wire is used in a wire. Therefore, weight reduction of the outer casing is necessary for use in a vehicle and the like in which fuel-efficiency is required for an environmental consideration purpose.

For weight reduction of the outer casing, simply, a light alloy wire such as an aluminum alloy wire may be used; however, in a case where the light alloy is used in a wire, compared to a case where a steel wire is used in a wire, it is considered that a problem such as generation of noise due to vibration transmission may occur along with the weight reduction of the outer casing. This problem of vibration is a problem in that, in a case where a light alloy having a relatively small specific weight is used in a wire, an energy required for causing a movement in the outer casing also becomes small, whereby the outer casing is easily vibrated, a vibration due to a vibration of an engine and the like is transmitted inside a vehicle, and a noise, a vibration, and the like are caused. In other words, a vibration from a vibration source such as an engine is transmitted inside the outer casing connected to the vibration source, causing the outer casing itself to vibrate. By vibrating an outer casing fixing part on a vehicle room side and the like connected to the vibration source through the outer casing by the transmitted vibration, a vibrational noise may be caused or rattling may occur to a member such as an outer casing fixing part.

In a case where the light alloy is used, it is also possible to consider suppressing transmissibility of the vibration by using a different part such as a buffer member and a muffling member; however, in such a case, it is not possible to achieve the weight reduction of a device as a whole due to an increase in the number of parts and an addition of weight of the buffer member, the muffling member, and the like.

As described above, if the weight of the outer casing is to be reduced, the problem of the vibration being transmitted occurs. In order to prevent the vibration from being transmitted, it is necessary to use a steel wire, which is heavy in weight, or to separately use a different member such as the buffer member or the muffling member for suppressing the transmissibility of the vibration. Therefore, an outer casing satisfying both demands for the weight reduction and the suppression of the transmissibility of the vibration has been sought after. Under such circumstances, an object of the present invention is to provide a control cable having an outer casing which is light weight, has the satisfactory buckling resistance, is capable of suppressing the transmissibility of the vibration, and is provided with a helically twisted metallic wire.

### Solution to Problem

A control cable according to the present invention is provided with an outer casing and an inner cable, in which the outer casing includes a liner, a plurality of wires helically twisted around the liner, and a covering layer formed outside the wires in a radial direction of the outer casing. A material of the wires is an aluminum alloy, and a pitch of the wires is 10 to 35 times as long as an outer diameter of a shield.

Furthermore, it is preferable that a cross section of the wires be a polygonal shape.

Furthermore, it is preferable that a tensile strength of the covering layer be from 29 to 50 MPa.

Furthermore, it is preferable that the aluminum alloy be an Al—Mg alloy or an Al—Mg—Si alloy.

### Advantageous Effects of Invention

According to the present invention, by using an aluminum alloy as a material of a wire used in an outer casing, weight reduction can be achieved, and by twisting the wire in a pitch of 10 to 35 times (more preferably 15 to 25 times) as long as an outer diameter of a shield, transmissibility of a vibration can be suppressed.

Furthermore, by using the wire having a polygonal cross section, particularly excellent buckling resistance can be obtained.

Furthermore, by configuring a tensile strength of a covering layer formed of a coating material to be from 29 to 50 MPa, the particularly excellent buckling resistance can be obtained.

Furthermore, in a case where an Al—Mg alloy or an Al—Mg—Si alloy is used as an aluminum alloy, it is preferred since a diameter of the wire can be easily reduced and the wire can be easily twisted, whereby the satisfactory buckling resistance can be obtained.

### BRIEF DESCRIPTION OF DRAWINGS

FIG. 1 is a partially notched schematic perspective view of a control cable according to one embodiment of the present invention.

FIG. 2 is a cross-sectional view of the control cable according to one embodiment of the present invention.

FIG. 3 is a cross-sectional view of the control cable in a longitudinal direction thereof according to one embodiment of the present invention.

FIG. 4 is a cross-sectional view of a control cable according to another embodiment of the present invention.

FIG. 5 is a schematic view of a device configured to measure a vibration damping characteristic in Examples and Comparative Examples.

FIG. 6 is a partially enlarged view of a device configured to measure the vibration damping characteristic in Examples and Comparative Examples.

FIG. 7 is a partially enlarged view of the device configured to measure the vibration damping characteristic in Examples and Comparative Examples.

FIG. 8 is a schematic view of a device configured to measure a crushing strength in Examples and Comparative Examples.

FIG. 9 is a graph illustrating a relationship between a frequency and an inertance value in Examples and Comparative Examples.

FIG. 10 is a partially notched schematic perspective view of a conventional control cable.

### DESCRIPTION OF EMBODIMENT

Hereinafter, a control cable according to the present invention is described in detail with reference to the attached drawings.

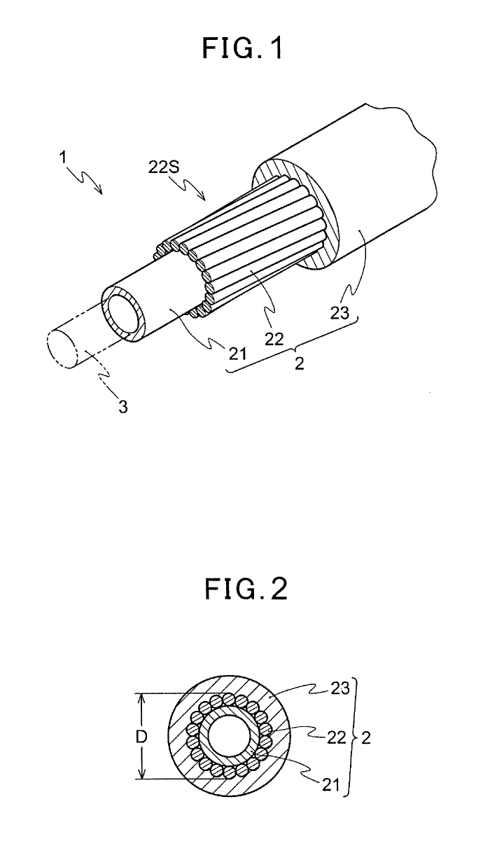

As illustrated in FIG. 1, a control cable 1 according to the present invention has a flexible tube shaped outer casing 2 and an inner cable 3 slidably housed inside the outer casing 2.

A twisted element wire such as a steel wire or a stainless steel wire is preferably employed as the inner cable 3; however, a diameter, the number of the element wires, and a twisting method of the inner cable 3 are not particularly limited in the present invention. Furthermore, as the inner cable 3, both an inner cable for a push-pull control cable and an inner cable for a pull control cable can be used.

The outer casing 2, as illustrated in FIG. 1, is provided with a liner 21, formed in a tube shape in an innermost layer of the outer casing 2 inside which the inner cable 3 slides, a plurality of wires 22 helically twisted around the liner 21, and a covering layer 23 formed outside the wires 22 in a radial direction of the outer casing 2. Note that hereinafter, “a plurality of wires helically twisted around the liner” means that both cases are included where the wires 22 are directly twisted around the liner 21 and where the wires 22 are indirectly twisted around the liner 21 such as by interposing a different layer. With regard to a method of twisting the wires 22, as long as the wires 22 are twisted around the liner 21, the adjacent wires 22 may be twisted densely having almost no interspace, or the wires 22 may be twisted at an interval.

Furthermore, the “covering layer” is a layer having a function to protect the wires 22 and to increase strength of the outer casing 2, and the covering layer 23 may be formed outside of the wires 22 in a radial direction of the outer casing 2. Therefore, there may be separately provided a different layer having a function other than to protect the wires 22 and to increase the strength of the outer casing 2 between the wires 22 and the covering layer 23 or outside the covering layer 23.

In FIG. 1, the outer casing 2 is illustrated to have a three-layer structure of the liner 21, the wires 22, and the covering layer 23; however, the present invention is not to be limited to a configuration illustrated in FIG. 1. It is needless to say that a configuration in which a different layer is further provided between the liner 21 and the wires 22, between the wires 22 and the covering layer 23, inside the liner 21, or outside the covering layer 23 is also included in the present invention.

The wires 22 used in the present invention are described herein. The wires 22 are helically twisted around the liner 21 as illustrated in FIG. 1, and form a shield layer 22S configured to secure buckling resistance of the outer casing 2. According to the present invention, an aluminum alloy is employed as the wires 22 to reduce the weight of the outer casing 2. By employing the aluminum alloy, compared with an outer casing in which a conventional steel material is used, the weight is reduced by about 20 to 50%, whereby it is possible to contribute to a weight reduction of a vehicle and the like in which the control cable 1 is to be routed.

A type of the aluminum alloy is not particularly limited as long as it has flexibility and buckling resistance such that it functions as an outer casing of a control cable; however, from a perspective of strength and workability, an Al—Mg alloy defined in JIS H4000 as a 5000-series material (hereinafter, simply referred to as “5000-series material”) or an Al—Mg—Si alloy defined as a 6000-series material (hereinafter, simply referred to as “6000-series material”), to which Mg is added, is preferably employed. Among the 5000-series materials and the 6000-series materials, from a perspective of the buckling resistance, it is further preferable that a material having the tensile strength of 350 to 600 MPa (tensile fracture strength defined in JIS Z2241) be used. Although depending on the tensile strength of the covering layer 23, when the tensile strength of the aluminum alloy, which is a material of the wires 22, is below 350 MPa, the outer casing 2 may be easily buckled or deformed, and when it exceeds 600 MPa, the flexibility and fatigability of the outer casing 2 may be slightly impaired.

Furthermore, with regard to the wires 22, as illustrated in FIG. 2, the wires 22 each having a circular cross-sectional shape is twisted so as to cover around the liner 21; however, the cross-sectional shape of the wires 22 is not limited. For example, it is possible to use the wires 22 each having a polygonal cross-sectional shape such as the wires 22 each having a trapezoidal cross-sectional shape as illustrated in FIG. 4. In FIG. 4, with regard to the cross section of the wires 22, by disposing trapezoids in parallel to each other such that an oblique side of a trapezoid contacts with an oblique side of another trapezoid, and by twisting the wires such that the plurality of wires 22 constitute the circular shield layer 22S, the crushing strength is increased and the buckling resistance is improved. In addition to the trapezoidal cross-sectional shape, the wires 22 may also have a polygonal cross-sectional shape such as a quadrangle including a square and a rectangle, a triangle, a pentagon, and the like. Furthermore, in such a case, it is possible to use a plurality of wires 22 having the same cross-sectional shape, or to combine the wires 22 having different cross-sectional shapes. Furthermore, besides the above-described wires 22 having the polygonal cross-sectional shape, it is also possible to twist wires 22 having an elliptical cross-sectional shape and disposed in parallel to each other.

The number of the wires 22 and a thickness of the shield layer 22S formed of the wires 22 (in the case where the wires 22 have a circular cross-sectional shape, a diameter of the wires 22) is not particularly limited, and as long as a relationship between the pitch of the wire 22 and the outer diameter of the shield described below is satisfied, the same number of wires and the same thickness of a shield layer of a wire used as a publicly known control cable can be directly applied. From such a viewpoint, for example, the thickness of the shield layer 22S may be selected in a range of 0.4 to 1.1 mm, and although not particularly limited, the number of wires 22 twisted around the liner 21 may be selected in a range of 18 to 24 wires.

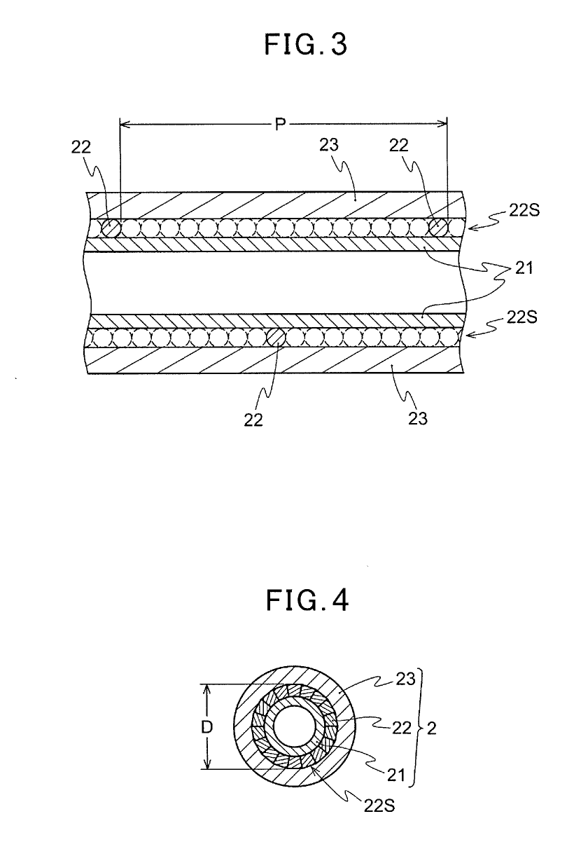

Next, the relationship between the pitch of the wires 22 and the outer diameter of the shield is described. As illustrated in FIG. 3, a pitch P of the wires 22 is a length in which one wire 22 is twisted around the liner 21 once in a longitudinal direction of the control cable 1 (a length in a longer direction of the control cable 1). As illustrated in FIGS. 2 and 4, an outer diameter of a shield D is an outer diameter of the shield layer 22S in a longitudinal section of the control cable 1 in which the shield layer 22S is formed by twisting the plurality of wires 22 around the liner 21.

In the present invention, by helically twisting the wires 22 at the pitch P of 10 to 35 times as long as the outer diameter of the shield D (hereinafter, the ratio of the pitch P to the outer diameter of the shield D (pitch P/outer diameter of the shield D) is referred to as “pitch magnification”), it is possible to reduce weight of the outer casing 2 and to suppress transmissibility of the vibration, which is a negative effect of the weight reduction.

In the present invention, a problem of a vibrational noise caused by the weight reduction of the wires 22 is solved by using an unprecedented approach to set the pitch magnification of the wires 22 in a range of 10 to 35, and it is not necessary to separately provide a different member such as a buffer member or a muffling member as a measure against the transmission of the vibration.

In the present invention, for vibrations in various frequencies generated from a vibration source, damping of vibration can be performed stably in a broad frequency band by setting the pitch magnification of the wires 22 in a range of 10 to 35. For example, when the pitch magnification of the wires 22 is smaller than 10, it is not easy to perform the damping of the vibrations from the vibration source, whereby the vibrations are easily transmitted inside the outer casing 2. On the other hand, when the pitch magnification of the wires 22 exceeds 35, the frequency band in which the damping can be performed is narrow, and in a high frequency band (for example, in the range where the frequency is higher than 4000 Hz) in particular, it is difficult to perform the damping of the vibrations. Furthermore, it is preferable that the pitch magnification of the wires 22 be set in a range of 15 to 25, since the vibration damping performance is further stabilized, whereby an effect of suppressing the transmissibility of the vibration is improved.

Next, a configuration other than the wires 22 is described. As the liner 21, a conventionally used publicly known liner may be used, and as long as the inner cable 3 can be inserted therein and the inner cable 3 can be slid inside, a material and a size thereof are not particularly limited.

The covering layer 23 covers the plurality of wires 22, and a material thereof is not particularly limited, and for example, a coating material similar to a conventional synthetic resin covering layer such as a polypropylene, a polyester thermoplastic elastomer, and a polyamide resin is preferably employed, and sizes such as layer thickness of the covering layer 23 is not limited. The strength of the covering layer 23 is designed by taking into account the strength of the liner 21 and the wires 22. Although the strength thereof is not particularly limited, it is possible to further improve the buckling resistance of the outer casing 2 by using a material having the tensile strength (tensile fracture strength defined in ASTM D638) of 29 to 50 MPa. Although depending on the tensile strength of the aluminum alloy of the wires 22 and the material of the liner 21, when the tensile strength of the material of the covering layer 23 is below 29 MPa, the outer casing 2 is easily buckled, and when the tensile strength exceeds 50 MPa, the flexibility of the outer casing 2 tends to be slightly impaired.

### EXAMPLES

Next, the present invention is specifically described with reference to Examples and Comparative Examples; however, the present invention is not to be limited to these Examples.

First, a vibration damping performance, a crushing strength, and a weight reduction index of the outer casing 2 measured in Examples and Comparative Examples are described.

(Vibration Damping Characteristic)

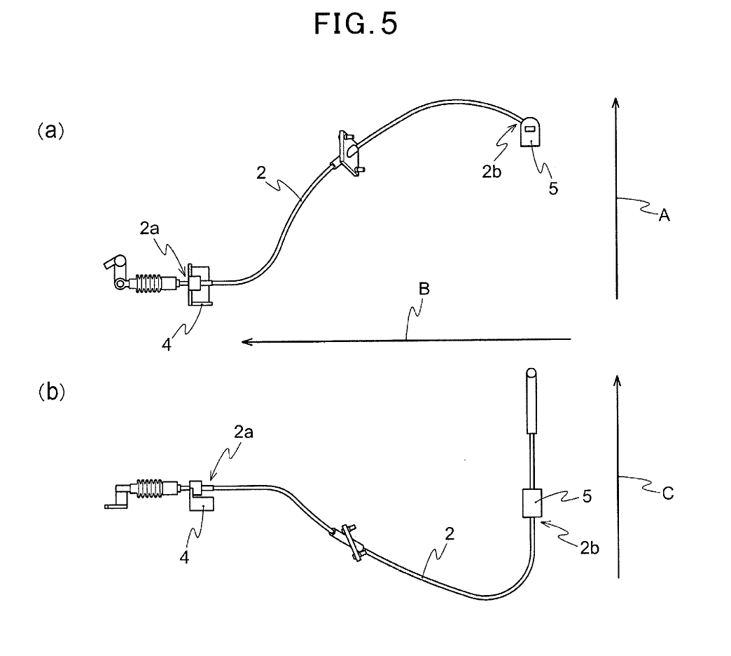

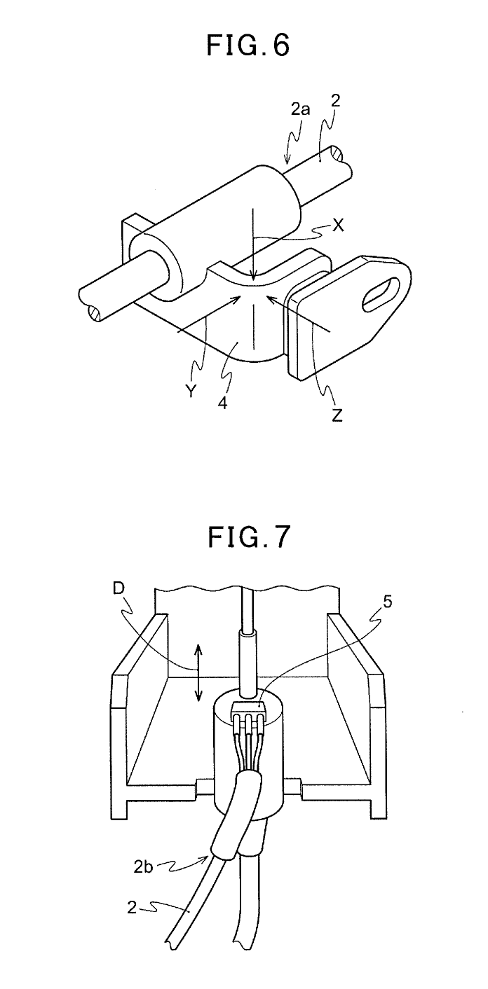

As illustrated in FIGS. 5(a) and 5(b), a side of one end 2a of the outer casing 2, which is a vibration-added side, is fixed to a metallic end fixture 4, and a side of another end 2b of the outer casing 2, which is a side to measure transmission of the vibration from an excitation side, an acceleration sensor 5 from RION Co., Ltd. is fixed using an adhesive, whereby routing is performed in a configuration actually installed in a vehicle. Note that in FIGS. 5(a) and 5(b), a direction denoted with a reference numeral A is a vehicle height direction, a direction denoted with a reference numeral B is a front-back direction of the vehicle, and a direction denoted with a reference numeral C is a vehicle width direction. FIG. 6 is an enlarged view of a coupling portion between the one end 2a of the outer casing 2, to which the vibration is added, and the end fixture 4, and reference numerals X, Y, and Z respectively denote a vertical direction X of a vehicle, a front-back direction Y of the vehicle, and a right and left direction Z of the vehicle. FIG. 7 is an enlarged view of a connecting portion between the acceleration sensor 5 and the other end 2b of the outer casing 2 in FIG. 5(b), and the acceleration sensor 5 is disposed such that a vibration in the vertical direction denoted with a reference numeral D in FIG. 7 is detected. To the acceleration sensor 5, an amplifier (not illustrated) from Ono Sokki Co., Ltd. and a FFT analyzer (not illustrated) from Ono Sokki Co., Ltd. are connected. The end fixture 4 to which the one end 2a of the outer casing 2, routed equivalent to an actual vehicle as described above, is attached is excited by an impact hammer (not illustrated) in the vertical direction X of the vehicle, in the front-back direction Y of the vehicle, and in the right and left direction Z of the vehicle. An answering wave generated at the time is detected by the acceleration sensor 5, and the answering wave detected by the acceleration sensor 5 is transmitted to the amplifier and the FFT analyzer as an electric signal, and by performing a frequency analysis by the FFT analyzer, a damping characteristic of the vibration is measured as an inertance value (dB/N). In the acceleration measurement, excitation is performed four times each in the vertical direction X of the vehicle, in the front-back direction Y of the vehicle, and in the right and left direction Z of the vehicle, and then an average of these inertance values are taken. An analysis frequency range is up to 5000 Hz.

As an evaluation criteria, along with an average inertance value of a frequency band from 500 to 5000 Hz, from a practical aspect, the vibration damping characteristic is evaluated as Excellent (⊙) if the inertance value transits in a range of −11 to +25 (unit: dB/N), it is evaluated as Satisfactory (◯) if the inertance value does not stay within the range of −11 to +25 (dB/N) and transits in the range of −15 to +30, and it is evaluated as Poor (x) in any other cases.

(Crushing Strength)

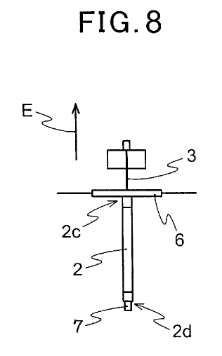

As illustrated in FIG. 8, the one end 2c of the 250 mm-long outer casing 2 is fixed to a fixing table 6, and another end 2d is fixed to a nipple 7. To the nipple 7, one end of the inner cable 3 having a length of 550 mm and an outer diameter of 2.5 mm is fixed, which is then inserted into the outer casing 2. The other end of the inner cable 3 is pulled in a direction denoted with a reference numeral E in FIG. 8 in a normal temperature at a speed of 20 mm/min, and a load (N) when the outer casing 2 is buckled is measured.

As an evaluation criteria, the crushing strength is evaluated as Excellent (⊙) if a load of 1.5 kN or above is endured, it is evaluated as Satisfactory (◯) if a load of 1.0 to 1.5 kN is endured, and it is evaluated as Poor (x) if a load is below that.

(Weight-Saving Index)

The index is evaluated considering a weight of the outer casing using the steel wire in Comparative Example 2 as 100.

### Example 1

21 wires 22 of an Al—Mg alloy (5056) having a circular cross-sectional shape (0.7 mm in diameter) are helically twisted around the polyethylene liner 21 having thickness of 0.5 ram and an outer diameter of 4.2 mm. The wires are twisted such that an outer diameter of a shield D is 4.90 ram and the pitch P is 50 mm (a pitch magnification of 10.2). Subsequently, the covering layer 23 is formed by covering the shield layer 22S with a polypropylene having the tensile strength of 20 MPa (ZELAS (registered trademark) of Mitsubishi Chemical Corporation: flexural modulus of 630 MPa defined in ASTM D790) to form the outer casing 2 of the control cable 1 having an outer diameter of 7 mm and of a type illustrated in FIG. 1 (and FIG. 2).

The vibration damping characteristic, the crushing strength, and the weight reduction index are studied for the manufactured outer casing 2. The results are illustrated in Table 1.

### Examples 2 to 15

Examples 2 to 15 are the same as Example 1 except for the type, the cross-sectional shape, the size, and the number of the wires 22 and the material of the covering layer 23, which are changed as illustrated in Table 1. An outer casing 2 having the same outer diameter, the outer diameter of the shield D, the pitch P, and the pitch magnification as illustrated in Table 1 is manufactured. The vibration damping characteristic, the crushing strength, and the weight reduction index are studied in the same way as Example 1. The results are illustrated in Table 1.

Note that the following materials are described in Table 1.

### (Aluminum Alloy)

5056: Al—Mg alloy defined in JIS H4040 having the tensile strength of 439 MPa
6063: Al—Mg—Si alloy defined in JIS H4040 having the tensile strength of 380 MPa

### (Covering Layer)

PP: ZELAS (registered trademark) from Mitsubishi Chemical Corporation having the tensile strength of 20 MPa and the flexural modulus of 630 MPa
TPEE (1): polyester elastomer from Toyobo Co., Ltd. (trade name PELPRENE (registered trademark) having the tensile strength of 30 MPa and the flexural modulus of 300 MPa)
TPEE (2): polyester elastomer from Du Pont-Toray Co., Ltd. (trade name Hytrel (registered trademark) having the tensile strength of 46 MPa and the flexural modulus of 570 MPa)
TPEE (3): polyester elastomer from Toyobo Co., Ltd. (trade name PELPRENE (registered trademark) having the tensile strength of 37 MPa and the flexural modulus of 490 MPa)
PBT: Polybutylene terephthalate from Mitsubishi Engineering-Plastics Corporation (trade name NOVADURAN (registered trademark) having the tensile strength of 29 MPa and the flexural modulus of 740 MPa)
Polyamide: polyamide from Du Pont Kabushiki Kaisha (trade name Zytel (registered trademark) having the tensile strength of 50 MPa and the flexural modulus of 520 MPa)

### Comparative Examples 1 to 3

Comparative Examples 1 to 3 are the same as Example 1, except that a galvanized hard steel wire is used as the wire, and the specification illustrated in Table 1 has been followed. An outer casing having the same outer diameter, the outer diameter of a shield, the pitch, and the pitch magnification as illustrated in Table 1 is manufactured, and the vibration damping characteristic, the crushing strength, and the weight reduction index are studied in the same way as Example 1. The results are illustrated in Table 1.

### Comparative Examples 4 to 8

Comparative Examples 4 to 8 are the same as Example 1 except that the specification illustrated in Table 1 has been followed. An outer casing for comparison having the outer diameter, the outer diameter of the shield, the pitch illustrated in Table 1 and a pitch magnification out of the present invention is manufactured, and the vibration damping characteristic, the crushing strength, and the weight reduction index are studied in the same way as Example 1. The results are illustrated in Table 1.

TABLE 1

| | SPECIFICATION | | | | | | | |
|---|---|---|---|---|---|---|---|---|
| | WIRE MATERIAL TYPE | | WIRE | | | | | |
| | STEEL | | CROSS | ALUMINUM | OUTER DIAMETER (mm) | | PITCH | PITCH |
| | WIRE | ALUMINUM | SECTION | ALLOY TYPE | OUTER | SHIELD | (mm) | MAGNIFICATION |
| EXAMPLE 1 | | ◯ | CIRCLE | 5000-SERIES | 7 | 4.90 | 50 | 10.2 |
| EXAMPLE 2 | | ◯ | CIRCLE | (5056) | 7 | 5.30 | 60 | 11.3 |
| EXAMPLE 3 | | ◯ | CIRCLE | | 7 | 5.60 | 100 | 17.9 |
| EXAMPLE 4 | | ◯ | CIRCLE | | 7 | 5.10 | 100 | 19.6 |
| EXAMPLE 5 | | ◯ | CIRCLE | | 7 | 4.90 | 120 | 24.5 |
| EXAMPLE 6 | | ◯ | CIRCLE | | 7 | 4.90 | 160 | 32.7 |
| EXAMPLE 7 | | ◯ | CIRCLE | | 8 | 5.20 | 100 | 19.2 |
| EXAMPLE 8 | | ◯ | CIRCLE | | 8 | 6.00 | 100 | 16.7 |
| EXAMPLE 9 | | ◯ | CIRCLE | | 8 | 6.00 | 100 | 16.7 |
| EXAMPLE 10 | | ◯ | CIRCLE | | 8 | 6.00 | 100 | 16.7 |
| EXAMPLE 11 | | ◯ | CIRCLE | | 9 | 6.95 | 120 | 17.3 |
| EXAMPLE 12 | | ◯ | CIRCLE | | 7 | 5.60 | 100 | 17.9 |
| EXAMPLE 13 | | ◯ | CIRCLE | | 7 | 5.60 | 100 | 17.9 |
| EXAMPLE 14 | | ◯ | TRAPEZOID | | 7 | 5.60 | 100 | 17.9 |
| EXAMPLE 15 | | ◯ | CIRCLE | 6000-SERIES | 7 | 5.60 | 100 | 17.9 |
| | | | | (6063) | | | | |
| COMPARATIVE | ◯ | — | CIRCLE | — | 7 | 4.90 | 40 | 8.2 |
| EXAMPLE 1 | | | | | | | | |
| COMPARATIVE | ◯ | — | CIRCLE | — | 7 | 4.90 | 87 | 17.8 |
| EXAMPLE 2 | | | | | | | | |
| COMPARATIVE | ◯ | — | CIRCLE | — | 7 | 4.90 | 180 | 36.7 |
| EXAMPLE 3 | | | | | | | | |
| COMPARATIVE | | ◯ | CIRCLE | 5000-SERIES | 7 | 4.90 | 41 | 8.4 |
| EXAMPLE 4 | | | | (5056) | | | | |
| COMPARATIVE | | ◯ | CIRCLE | | 7 | 5.60 | 210 | 37.5 |
| EXAMPLE 5 | | | | | | | | |
| COMPARATIVE | | ◯ | CIRCLE | | 8 | 5.20 | 45 | 8.7 |
| EXAMPLE 6 | | | | | | | | |
| COMPARATIVE | | ◯ | CIRCLE | | 8 | 6.20 | 225 | 36.3 |
| EXAMPLE 7 | | | | | | | | |
| COMPARATIVE | | ◯ | CIRCLE | | 8 | 7.70 | 288 | 37.4 |
| EXAMPLE 8 | | | | | | | | |

| | | | EVALUATION | | | |
|---|---|---|---|---|---|---|
| | SPECIFICATION | | | VIBRATIONAL NOISE | | |
| | COVERING LAYER | | WEIGHT | AVERAGE | | |
| | RESIN | STRENGTH | REDUCTION | INERTANCE | | BUCKLING |
| | TYPE | (MPa) | INDEX | (dB) | EVALUATION | RESISTANCE |
| EXAMPLE 1 | PP | 20 | 65 | −10 to 28 | ◯ | ◯ |
| EXAMPLE 2 | | | 60 | −13 to 25 | ◯ | ◯ |
| EXAMPLE 3 | | | 55 | −11 to 22 | ⊙ | ◯ |
| EXAMPLE 4 | | | 53 | −11 to 25 | ⊙ | ⊙ |
| EXAMPLE 5 | | | 53 | −11 to 25 | ⊙ | ⊙ |
| EXAMPLE 6 | | | 52 | −13 to 29 | ◯ | ⊙ |
| EXAMPLE 7 | | | 51 | −11 to 21 | ⊙ | ⊙ |
| EXAMPLE 8 | | | 51 | −11 to 20 | ⊙ | ◯ |
| EXAMPLE 9 | TPEE(1) | 30 | 71 | −11 to 20 | ⊙ | ⊙ |
| EXAMPLE 10 | TPEE(2) | 46 | 71 | −11 to 20 | ⊙ | ⊙ |
| EXAMPLE 11 | TPEE(3) | 37 | 70 | −10 to 22 | ⊙ | ⊙ |
| EXAMPLE 12 | PBT | 29 | 70 | −11 to 25 | ⊙ | ⊙ |
| EXAMPLE 13 | POLYAMIDE | 50 | 68 | −11 to 25 | ⊙ | ⊙ |
| EXAMPLE 14 | PP | 20 | 58 | −11 to 25 | ⊙ | ⊙ |
| EXAMPLE 15 | | | 58 | −11 to 25 | ⊙ | ◯ |
| COMPARATIVE | PP | 20 | 100 | −10 to 28 | ◯ | ⊙ |
| EXAMPLE 1 | | | | | | |
| COMPARATIVE | | | 99 | −10 to 28 | ◯ | ⊙ |
| EXAMPLE 2 | | | | | | |
| COMPARATIVE | | | 98 | −10 to 28 | ◯ | ⊙ |
| EXAMPLE 3 | | | | | | |
| COMPARATIVE | | | 100 | 18 to 55 | X | ◯ |
| EXAMPLE 4 | | | | | | |
| COMPARATIVE | | | 95 | −55 to 40 | X | ⊙ |
| EXAMPLE 5 | | | | | | |
| COMPARATIVE | | | 100 | 33 to 59 | X | ◯ |
| EXAMPLE 6 | | | | | | |
| COMPARATIVE | | | 95 | −28 to 59 | X | ⊙ |
| EXAMPLE 7 | | | | | | |
| COMPARATIVE | | | 94 | −31 to 62 | X | ⊙ |
| EXAMPLE 8 | | | | | | |

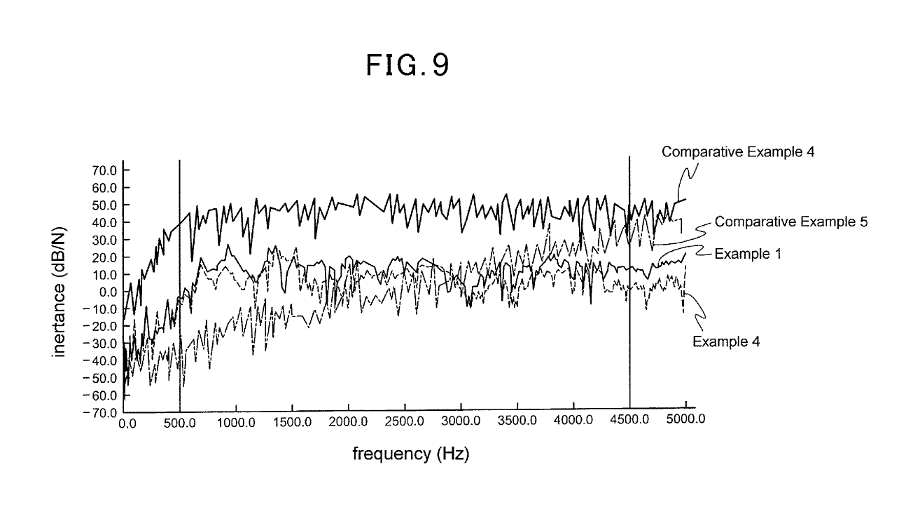

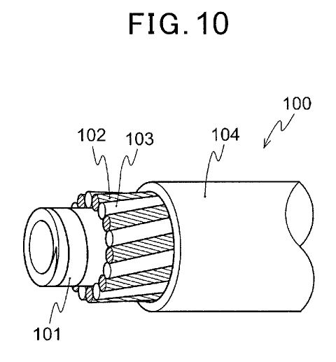

Furthermore, in FIG. 9, a relationship between the frequency and the inertance value is illustrated for Example 1, Example 4, Comparative Example 4, and Comparative Example 5 in Table 1. In FIG. 9, a horizontal axis represents the frequency (Hz) and a vertical axis represents the inertance (dB/N). As illustrated in FIG. 9, in a case of Example 1 having the pitch magnification of 10.2 or Example 4 having the pitch magnification of 19.6, it is apparent that the outer casing 2 has a stable vibration damping performance in a frequency between 500 and 4500 Hz.

In contrast, in a case of Comparative Example 4 in which the pitch magnification is smaller than 10 (pitch magnification 8.4), the inertance value exceeds 25 dB/N in almost the entire range of the frequency between 500 and 4500 Hz, whereby it is apparent that the vibration damping performance is low. Furthermore, in a case of Comparative Example 5 in which the pitch magnification is larger than 35 (pitch magnification is 37.5), the inertance value rises as the frequency becomes higher, and the vibration damping performance becomes lower. Around the frequency of 3000 Hz, the inertance value exceeds that of Example 1, and around the frequency of 4000 Hz, the inertance value exceeds 25 dB/N, and it is apparent that the vibration damping performance becomes low. In other words, in a case where the pitch magnification is larger than 35, it is apparent that a stable vibration damping performance cannot be obtained in the frequency band between 500 and 5000 Hz.

That is, according to Table 1 and FIG. 9, it is apparent that, when the pitch magnification is within the range of that of the present invention, the high vibration damping performance can be stably obtained in a broad frequency band between 500 and 5000 Hz and an excellent vibration damping characteristic can be provided against various vibrations caused by a vibration source.

On the other hand, in a case where the pitch magnification is smaller than 10, the vibration damping performance itself is low, whereby the vibration caused by a vibration source cannot be effectively damped. Furthermore, in the case where the pitch magnification is larger than 35, the vibration damping performance is different for each frequency band, and when the frequency reaches 4000 Hz or above, the vibration cannot be effectively damped, whereby it is not possible to deal with various vibrations caused by a vibration source.

Next, considering Table 1, in Examples 1 and 2 in which the pitch magnifications are 10.2 and 11.3, respectively, the vibrational noise is evaluated as Satisfactory, and by increasing the pitch magnification to 10 or above, it is apparent that the vibrational noise can be suppressed while using an aluminum alloy in the wire for reducing the weight.

In Example 3, the pitch magnification is 17.9, and the vibrational noise is evaluated as Excellent. In Examples 4 and 5, the pitch magnifications are 19.6 and 24.5, respectively, and the vibrational noise is evaluated as Excellent. In Example 6, the pitch magnification is 32.7, and the vibrational noise is evaluated as Satisfactory. In Examples 7 and 8, an outer diameter of the outer casing 2 is configured to be 8 mm, the pitch magnifications are 19.2 and 16.7, respectively, and the vibrational noise is evaluated as Excellent for both. From these results in Examples 3 to 8, it is apparent that the performance to damp a vibration transmitted particularly from the vibration source is high when the pitch magnification is within the range of 15 to 25.

In Example 15, a 5000-series (5056) aluminum alloy, which is a material of the wires 22 in Example 3, is changed to a 6000-series (6063) aluminum alloy. In Example 15, same as Example 3, the vibrational noise is evaluated as Excellent, and it is apparent that the same effect can be obtained by using the 6000-series material as the aluminum alloy.

On the other hand, in Comparative Examples 1 to 3 in which the steel wire is used as the wires 22, the weight reduction index of the outer casing 2 is between 98 and 100, while the weight reduction index of the outer casing 2 in Examples 1 to 15 is between 51 and 71. Compared to Comparative Examples 1 to 3 in which the steel wire is used, it is apparent that the weight is further reduced. Therefore, according to Examples 1 to 15, while achieving the weight reduction, it is apparent that it has the same vibration damping performance as an outer casing in which the conventional steel wire is used.

Furthermore, since the weight is heavy in Comparative Examples 1 to 3, the vibration caused by a vibration source can be easily damped, whereby the vibrational noise is evaluated as Satisfactory. Nevertheless, in Comparative Examples 1 to 3 in which the steel wire is used as the wires 22, in any of the cases where the pitch magnifications are 8.2, 17.8, and 36.7, the average inertance value transits within a range of the same values in the range of the frequency between 500 and 5000 Hz, whereby when the steel wire is used as the wires 22, it is apparent that the damping of the vibration is not affected even if the pitch magnification is changed. It is considered that the vibration transmissibility is not changed even if a structure (pitch magnification) is changed because the steel wire used as the wires 22 has a small contribution ratio of a frictional force relative to a mass. In contrast, an aluminum alloy having a lighter mass than a steel wire has a lower vibration damping performance according to a calculation, but since the aluminum alloy has a larger contribution ratio of the frictional force relative to the mass, the vibration transmissibility is largely affected by a change in the structure (pitch magnification). The present inventor has focused on this point and, by using an aluminum alloy having a larger friction coefficient than the steel wire as the structure and by using a predetermined pitch magnification, has converted vibrational energy into thermal energy and significantly increased the vibration damping performance.

In Comparative Examples 4 and 6, the pitch magnifications are 8.4 and 8.7, respectively, which are smaller than 10, and the vibrational noise is evaluated as Poor for both. From the results of Comparative Examples 4 and 6, it is apparent that when the pitch magnification is smaller than 10, the average inertance value becomes high, and the vibration from the vibration source is not easily damped, whereby the vibration is easily transmitted.

In Comparative Examples 5, 7, and 8, the pitch magnifications are 37.5, 36.3, and 37.4, respectively, which are larger than 35, and the vibrational noise is evaluated as Poor for all of them. From the results of Comparative Examples 5, 7, and 8, in a range where the pitch magnification is larger than 35, a range of fluctuation of the inertance value is large with the average inertance value ranging from around −30 to 50 or 60, whereby it is apparent that there is no stable vibration damping performance. Furthermore, from Comparative Examples 5, 7, and 8, it is apparent that a transition of the average inertance value is almost the same even if the outer diameter of the outer casing or the outer diameter of the shield layer is changed, that there is no relevancy between the outer diameter of the outer casing or the outer diameter of the shield layer and the average inertance value, and that the average inertance value depends on the pitch magnification.

According to Table 1, as in Examples 1 to 15, in a case where the aluminum alloy is used as the wires for achieving the weight reduction, when the pitch magnification is in the range between 10 and 35, the average inertance value is in the range between −13 and 29 dB/N for all of Examples 1 to 15, whereby it is apparent that a stable vibration damping performance is provided in a broad frequency band.

With regard to the buckling resistance, from Example 4, it is apparent that the buckling resistance can be increased by setting the pitch magnification to 19 or above. Furthermore, as illustrated in Examples 9 and 10, by changing the polypropylene (tensile strength of 20 MPa), which is the material of the covering layer 23 in Example 8, to PELPRENE (registered trademark) (tensile strength of 30 MPa) and Hytrel (registered trademark) (tensile strength of 46 MPa) respectively, which are polyester elastomer, it is apparent that the buckling resistance is improved. Furthermore, in a case where the tensile strength of the material of the covering layer 23 (Examples 9 to 13) is increased, it is apparent that the buckling resistance is increased in any of the cases. Furthermore, it is apparent that the material of the covering layer 23 does not affect the evaluation of the vibrational noise, while the pitch magnification affects the evaluation of the vibrational noise.

In Example 14, the cross-sectional shape of the wires 22 in Example 3 is changed to a trapezoid, and the evaluation of the vibrational noise did not change but the buckling resistance is evaluated as Excellent. Accordingly, it is apparent that the buckling resistance can be improved by using a polygonal cross-sectional shape such as a trapezoid for the wires 22.

### REFERENCE SIGNS LIST

1 Control cable
2 Outer casing
21 Liner
22 Wire
23 Covering layer
3 Inner cable
4 End fixture
5 Acceleration sensor
6 Fixing table
7 Nipple

1. A control cable comprising an outer casing and an inner cable,
wherein the outer casing includes:
a liner;
a plurality of wires helically twisted around the liner; and
a covering layer formed outside the wires in a radial direction of the outer casing,
wherein a material of the wires is an aluminum alloy, and a pitch of the wires is 10 to 35 times as long as an outer diameter of a shield.

2. The control cable according to claim 1, wherein a cross section of the wires is a polygonal shape.

3. The control cable according to claim 1, wherein a tensile strength of the covering layer is between 29 and 50 MPa.

4. The control cable according to claim 2, wherein a tensile strength of the covering layer is between 29 and 50 MPa.

5. The control cable according to claim 1, wherein the aluminum alloy is an Al—Mg alloy or an Al—Mg—Si alloy.

6. The control cable according to claim 2, wherein the aluminum alloy is an Al—Mg alloy or an Al—Mg—Si alloy.

7. The control cable according to claim 3, wherein the aluminum alloy is an Al—Mg alloy or an Al—Mg—Si alloy.

8. The control cable according to claim 4, wherein the aluminum alloy is an Al—Mg alloy or an Al—Mg—Si alloy.
